(19) United States
(12) Patent Application Publication
(10) Pub. No.: US 2011/0146162 A1
(43) Pub. Date: Jun. 23, 2011

(54) TEMPORARY CLOSURES FOR A ROOM VENT

(75) Inventor: Gavin Andrew Kilhams, Hampshire (GB)

(73) Assignee: BIOQUELL UK LIMITED, Andover (GB)

(21) Appl. No.: 12/838,042

(22) Filed: Jul. 16, 2010

(30) Foreign Application Priority Data
Dec. 18, 2009 (GB) 0922243.1

(51) Int. Cl. E06B 7/00

(52) U.S. Cl. 49/463

(57) ABSTRACT

This invention relates to temporary closures for a room vent and is particularly although not exclusively applicable to temporary closures for room vents to enable a room to be sterilised by circulating sterilant vapour without allowing vapour to enter the vent or gas to enter the room from the vent during the sterilising operation. The temporary closure comprises a hood to extend over the vent having a peripheral seal for engaging a surface around the vent and a telescopically extendable strut on which the hood is mounted to engage a fixed surface disposed opposite the vent to hold the hood in place over the vent.

### BACKGROUND OF THE INVENTION

1. The Field of the Invention

This invention relates to temporary closures for a room vent and is particularly although not exclusively applicable to temporary closures for room vents to enable a room to be sterilised by circulating sterilant vapour without allowing vapour to enter the vent or gas to enter the room from the vent during the sterilising operation.

2. The Relevant Technology

For example, the heating, ventilation and air-conditioning (HVAC) within hospitals is controlled by Building Management Systems (BMS). The vent within the ceiling of these rooms is typically 610 mm square.

Present practice either involves using valves to turn off the HVAC if possible; or, to use plastic and tape to cover, or to inflate a balloon in the duct. Essentially the methods deployed currently are time consuming and involve doing something either to the duct or grille; having to employ ladders.

### SUMMARY OF THE INVENTION

The present invention relates principally to a method of sealing and covering the ceiling vent within these rooms so that the room can be bio-decontaminated ensuring no leakage of sterilant vapour out of the room during the bio-decontamination process.

The setup time during room bio-decontamination is critical as minimising the downtime of the room is crucial. The invention relates specifically to an apparatus for the quick sealing of the HVAC vent opening; which can be used at ground level.

This invention provides a temporary closure for a room vent located in a wall or ceiling of a room, comprising a hood to extend over the vent having a peripheral seal for engaging a surface around the vent and a telescopically extendable strut on which the hood is mounted to engage a fixed surface disposed opposite the vent to hold the hood in place over the vent.

In one arrangement according to the invention the strut has means for extending the strut to engage the hood against the surface around the vent and to release said extension means to allow the strut to be retracted.

Specifically, the strut may comprise an elongate sleeve and an elongate rod projecting from the sleeve, the hood being attached to the rod and a sleeve having means to act on the rod to extend the rod from the sleeve and to allow retraction of the rod into the sleeve.

In the latter case scissor action handles may be mounted on the sleeve adjacent the end from which the rod projects for operating a means for extending the rod from the sleeve and for releasing the rod for retraction into the sleeve.

### BRIEF DESCRIPTION OF THE DRAWINGS

The following is a description of some specific embodiments of the invention, reference being made to the accompanying drawings in which:

FIG. 1 is a perspective view from below of a temporary closure for a ceiling vent of a room such as a hospital ward;

FIG. 3 is a perspective view from above of the components of the closure exploded apart for illustration purposes; and

FIGS. 4 and 5 show the manner of assembly of the closure.

### DETAILED DESCRIPTION OF THE PREFERRED EMBODIMENTS

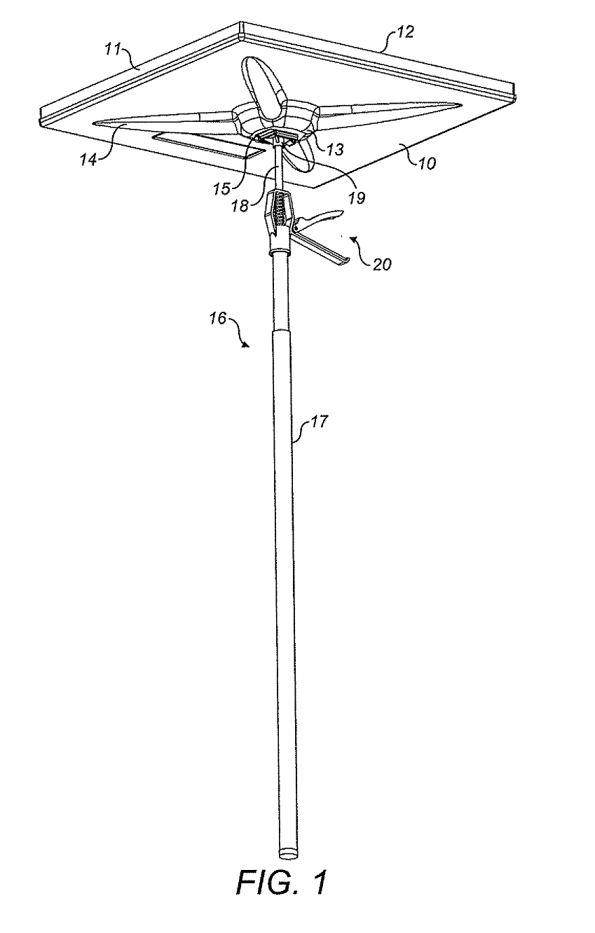

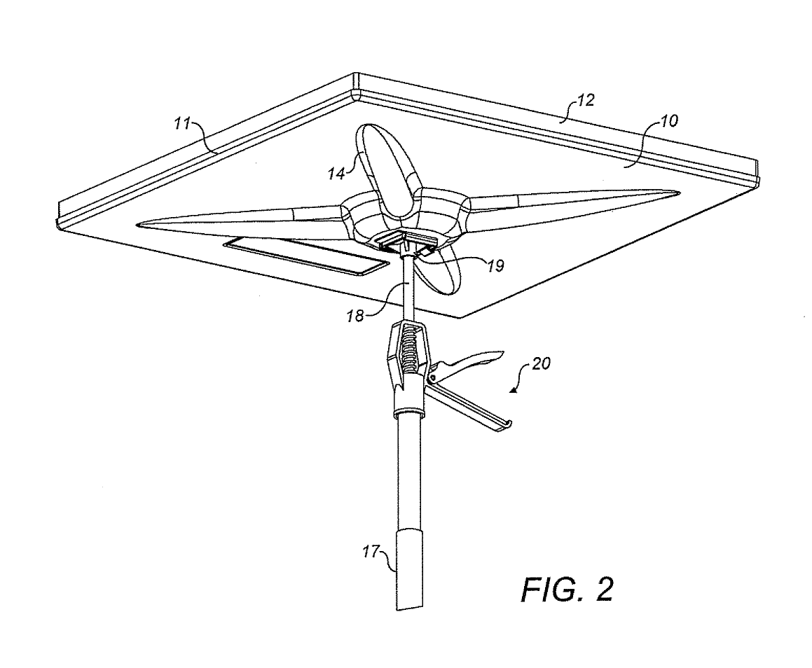

Referring firstly to FIGS. 1 and 2 of the drawings, there is shown a temporary closure for a ceiling vent of a room comprising an inverted hood 10, having a square profile and being dimensioned to span vents (inlets or outlets) as utilised in public buildings such as hospitals, including hospital wards. The hood has an outstanding peripheral edge 11 within which a continuous peripheral seal 12 is mounted to encircle the ceiling vent to be closed by the apparatus.

The hood has a central boss 13 formed on its underside with diagonally extending ribs 14 to assist in supporting the boss and a mounting plate 15 at the centre of the boss. The hood is mounted on a telescopic strut indicated at 16 comprising a sleeve 17 having a projecting rod 18 at its upper end fitted with a cap 19 which is secured to the plate mounted on the boss of the hood.

A standard mechanism indicated at 20 is mounted at the upper end of the sleeve comprising a fixed handle 21, a pivoting handle 22 and an arrangement of clips operated by a scissor action of the handles to cause the rod to extend from the sleeve and thereby raise the hood with a release position to enable the rod to retract back into the sleeve.

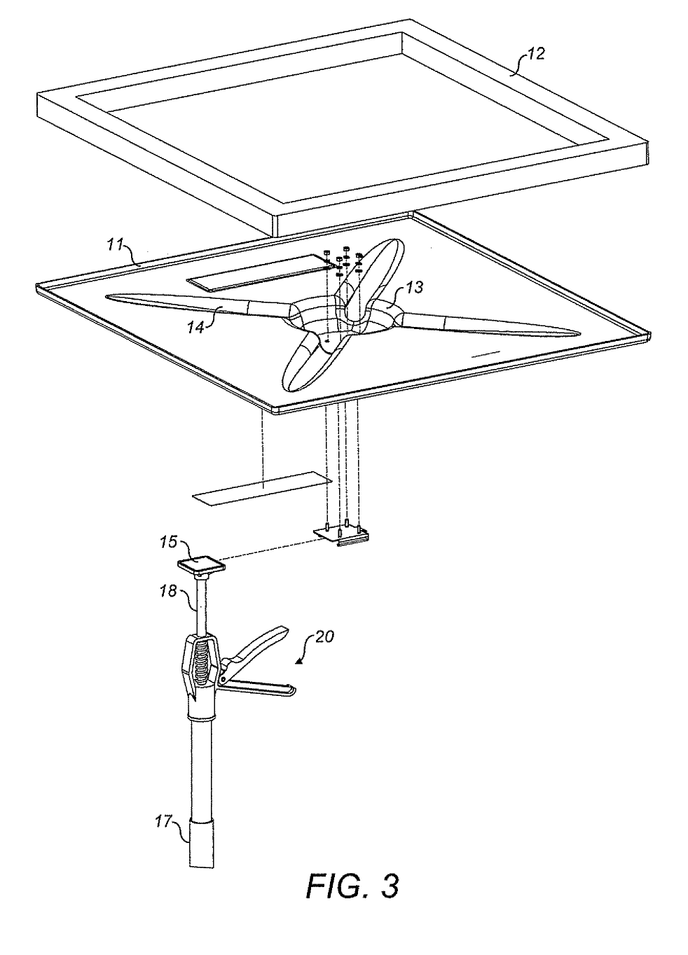

FIG. 2 is a close up of the arrangement shown in FIG. 1 illustrating the mechanism for operating the rod at the top of the sleeve in greater detail and FIG. 3 shows the components comprising the hood and rod exploded to show how they fit together.

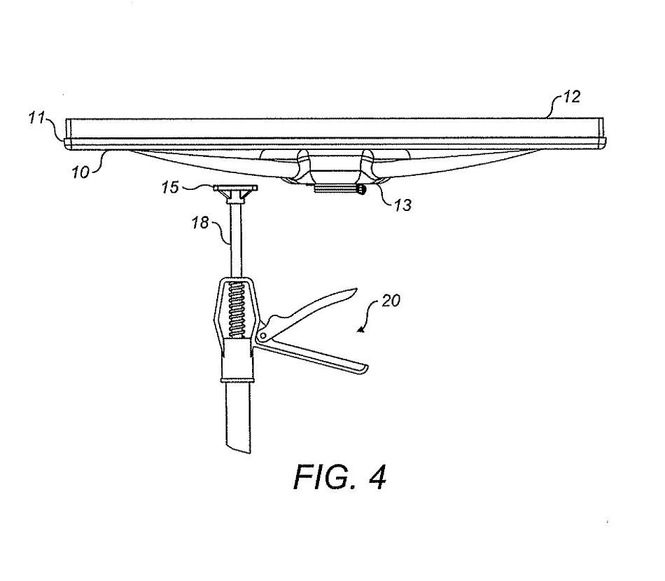

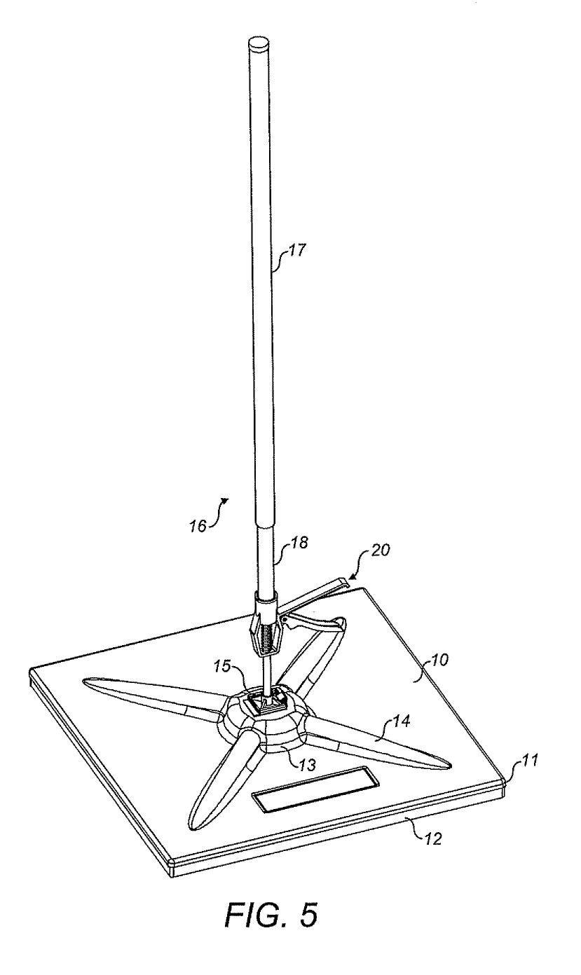

FIGS. 4 and 5 illustrate how the hood is mounted on the cap at the upper end of the rod by means of the mounting plate secured to the boss on the underside of the hood.

A ceiling vent of a room to be decontaminated such as a hospital ward is temporarily closed to prevent escape of sterilant vapour into the ducting behind the vent or flow of air from the vent into the room by the temporary closure described above. The closure is placed underneath the vent with the hood uppermost and the lower end of the strut on the ground or possibly a table or other horizontal surface. The strut is extended using the scissor action device 20 to raise the hood into engagement with the vent with the seal firmly pressed against the surface surrounding the vent to close the vent from the room for sterilisation of the room. When the process is over, the clamping device is released to allow the strut to be retracted ready for the next operation.

What is claimed is:

1. Temporary closure for a room vent located in a wall or ceiling of a room, comprising:
a hood to extend over the vent having a peripheral seal for engaging a surface around the vent; and
a telescopically extendable strut on which the hood is mounted to engage a fixed surface disposed opposite the vent to hold the hood in place over the vent.

2. A temporary closure as claimed in claim 1 having means for extending the strut to engage the hood against the surface around the vent and to lock the strut and hood in place and to release said extension means to allow the strut to be retracted.

3. A temporary closure as claimed in claim 1 wherein the strut comprises an elongate sleeve and an elongate rod projecting from the sleeve, the hood being attached to the rod and a sleeve having means to act on the rod to extend the rod from the sleeve and to allow retraction of the rod into the sleeve.

4. A temporary closure as claimed in claim 3, wherein scissor action handles are mounted on the sleeve adjacent the end from which the rod projects for operating a means for extending the rod from the sleeve and for releasing the rod for retraction into the sleeve.

5. A temporary closure as claimed in claim 2 wherein the strut comprises an elongate sleeve and an elongate rod projecting from the sleeve, the hood being attached to the rod and a sleeve having means to act on the rod to extend the rod from the sleeve and to allow retraction of the rod into the sleeve.

6. A temporary closure as claimed in claim 5, wherein scissor action handles are mounted on the sleeve adjacent the end from which the rod projects for operating a means for extending the rod from the sleeve and for releasing the rod for retraction into the sleeve.
